(19) United States
(12) Patent Application Publication
(10) Pub. No.: US 2003/0187528 A1
(43) Pub. Date: Oct. 2, 2003

(54) Efficient implementation of audio special effects

(76) Inventors: Ke-Chiang Chu, Saratoga, CA (US); Krishna Sherigara Mala, Kirkland, WA (US); Sree Ramesh Karukonda, Kirkland, WA (US)

Correspondence Address: K. Jun Kim, Gray Cary Ware & Freidenrich LLP, 1755 Embarcadero Road, Palo Alto, CA, 94303-3340, US

(21) Appl. No.: 10/116,659

(22) Filed: Apr. 2, 2002

(51) Int. Cl. G06F 17/00; G06F 7/50

(52) U.S. Cl. 700/94

(57) ABSTRACT

The present invention provides signal processing method and apparatus for audio special effect processing on an input signal. The signal processing system of the invention eliminates the need for FFT and inverse FFT operations from an audio signal decoding system by providing au audio special effect processing routine before a frequency-to-time conversion. The audio special effect processing routine may perform equalization and/or base boost operations. After an input signal is processed by the, the modified input signal is converted to a time-domain signal by a frequency-to-time conversion unit so that audible sound may be generated based on the time-domain signal. The frequency-to-time conversion unit may comprise an MDCT (modified discrete cosine transform) routine and comprise a synthesizer filter.

### FIELD OF THE INVENTION

This invention relates generally to a signal processing system. More specifically, the invention relates to a special effect processing technique for audio signals.

### BACKGROUND OF THE INVENTION

Signal processing has many applications. Especially for audio signals, special effect processing is popular and sometimes necessary technique to enhance the quality of the audio signal. Audio special effects include equalization (EQ) and base boost (BB) techniques. Such audio special effects require selectively altering the spectral signal power in the frequency domain. For example, the base boost needs to boost or cut the baseband signal power. Equalization needs to boost or cut the signal power of the selected frequency bands with desired gains.

One of the challenges in audio special effect processing lies in the fact that most of the time, audio signal is available in the form of Pulse-Coded Modulation (PCM) in the time domain. Since audio special effect processing is typically performed in the frequency domain, audio processing of PCM signal requires a time-to-frequency conversion and another conversion from frequency-to-time conversion, making the implementation of audio special effect processing an expensive and complex process.

Typical solution for audio special effect processing is to first transform the time domain PCM signals, s(t), to frequency domain with Fast-Fourier Transform (FFT). The spectral components in the frequency domain, S(f), are then altered by boosting (or cutting) the signal power of the selected frequency bands. The modified spectral components, S′(f), are transformed back to the time domain by Inverse Fast-Fourier Transform (IFFT).

FFT and IFFT may be defined as:

$$\begin{matrix}S ( f ) = {\int }_{- ∞}^{∞} S ( t ) {ⅇ}^{- j 2 π f t} ⅆ t \\ {s}^{′} ( t ) = {\int }_{- ∞}^{∞} {S}^{′} ( f ) {ⅇ}^{j 2 π f t} ⅆ f\end{matrix}$$

FIG. 1 illustrates a prior art audio signal processing system where PCM signal is converted using FFT algorithm. In FIG. 1, data portion of input signal is processed by Huffman decoding unit 101 and scale factors are processed by Huffman decoding unit 103. The input signal is typically encoded by a corresponding Huffman encoder before arriving at Huffman decoding units 101 and 103. The decoding by units 101 and 103 may be executed in parallel as shown in FIG. 1, or may be executed in a sequential manner. The outputs of the Huffman decoding units 101 and 103 are combined and provided to dequantizer 105, which in turn is coupled to stereo processing unit 107. The output of the stereo processing unit 107 is provided to inverse MDCT (Modified Discrete Cosine Transform) unit 109, which is coupled to synthesizer filter 111. The output of the synthesizer filter 111 is PCM signal, which is provided to FFT unit 113. The output of the FFT unit 113 is coupled to special effect processing unit 115, whose output is coupled to inverse FFT unit 117. The special effect processing unit 115 typically performs equalization and/or base boost. The output of the inverse FFT unit 117 is PCM signal modified by the special effect processing unit 115.

Although the FFT and IFFT are quite straightforward in their mathematical expressions, actual implementation of the FFT and IFFT are very compute-intensive processes. This prompted many researches in an effort to develop fast FFT/IFFT algorithms. Some algorithms were developed for hardware implementation, and some others were designed for software implementation. Whether it is a software-friendly algorithm or hardware-friendly algorithm, it is still a quite expensive process for embedded applications where FFT and IFFT are implemented as part of a larger overall system.

A conventional technique used for base boost is to design a low-pass filter hₗₚ(t) in the time domain. The filter boosts (or cuts) the signal power for base band spectral components in the frequency domain. Such low pass filter is well-known in the art and thus not discussed in detail. The low-pass filter is convolved with the PCM data. The output of the convolution is the modified PCM data with boosted base band energy. Where the “convolution” may be defined as:

$${s}^{′} ( t ) = s ( t ) * {h}_{lp} ( t ) = {\int }_{- ∞}^{+ ∞} s ( x ) {h}_{lp} ( t - x ) ⅆ x$$

With this approach, the processing time may be reduced for base boost processing. However, for equalization application, it takes one band-pass filter (or shelving filter) for each critical band, requiring one convolution for each selected band. For example, for a 10-band equalizer, we need ten (10) band-pass filters (or shelving filters). Typically, it would take ten (10) or more convolutions for each PCM sample. As a result, the processing time for equalization is increased by a factor of 10, making it prohibitively slow for most of the embedded applications.

In view of the foregoing, it is highly desirable to provide a flexible, cost-efficient audio special effect processing techniques. It is also desirable to provide an efficient audio special effect processing technique without compromising processing speed so that the audio processing can meet the high data processing speeds required by high-performance digital signal processing systems.

### SUMMARY OF THE INVENTION

The present invention provides signal processing method and apparatus for audio special effect processing on an input signal. The signal processing system of the invention eliminates the need for FFT and inverse FFT operations from an audio signal decoding system by providing audio special effect processing routines before a frequency-to-time conversion. The audio special effect processing routine may perform equalization and/or base boost operations. After an input signal is processed by the modified input signal is converted to a time-domain signal by a frequency-to-time conversion unit so that audible sound may be generated based on the time-domain signal.

The frequency-to-time conversion unit may comprise an MDCT (modified discrete cosine transform) routine and comprise a synthesizer filter. The synthesizer filter receives the output of the inverse MDCT operation and synthesizes a time-domain signal that may be used to generate audible sounds. The synthesizer filter may have an oscillator to synthesize time-domain signals and use various filters to enhance sound quality. The frequency-to-time signal conversion may be performed by an FFT (for AAC), polyphase filterbank—DCT combination (for MP3) or other suitable method.

The present invention may also provide a decoder unit for an input signal; an inverse quantization unit, a stereo processing unit for performing a two track sound coding. The inverse quantization unit performs inverse quantization to recover an approximated form of the original waveform. The stereo processing unit may perform a variety of multi-track processing operations including L-R coding (Left-to-Right channel), M-S (Middle-Side) coding, and intensity coding.

### BRIEF DESCRIPTION OF THE DRAWINGS

For a better understanding of the invention, reference should be made to the following detailed description taken in conjunction with the accompanying drawings, in which:

FIG. 1 illustrates a prior art audio signal processing system where an FFT algorithm is used to convert PCM signals;

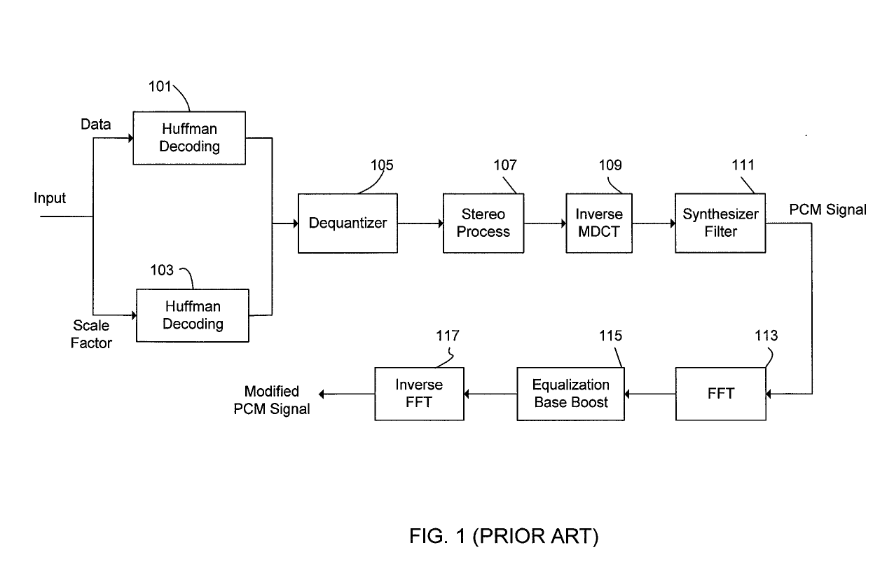

FIG. 2 illustrates a signal processing system in accordance with one embodiment of the invention; and

FIG. 3 illustrates a flowchart of signal processing in accordance with one embodiment of the invention.

Like reference numerals refer to corresponding parts throughout the drawings.

### DETAILED DESCRIPTION OF A PREFERRED EMBODIMENT

The invention is particularly applicable to special effect processing for audio signals, and it is in this context that the invention will be described. It will be appreciated, however, that the invention has greater utility, such as to other types of signal processing applications. To understand the invention, the basic structure of the special effect signal processing and its operations will be described.

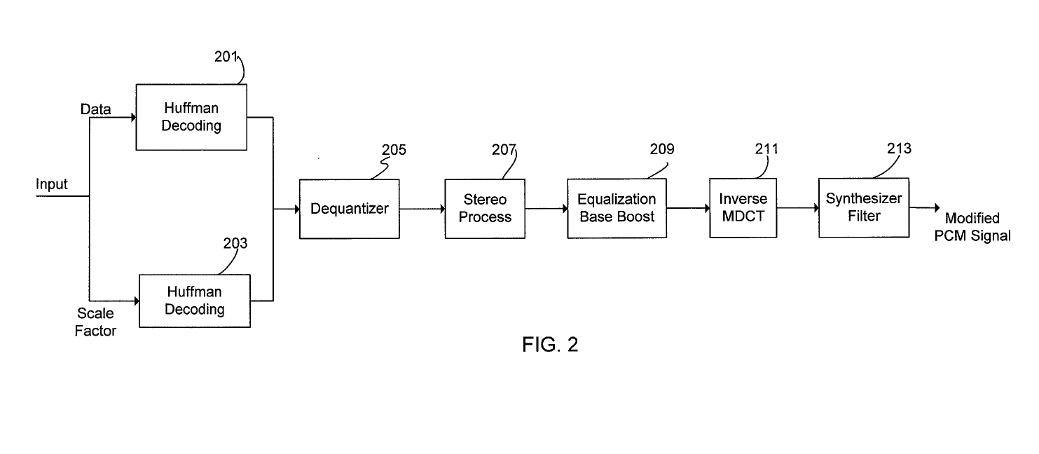

FIG. 2 illustrates a signal processing system in accordance with one embodiment of the invention. The whole signal processing system shown in FIG. 2 is frequently referred to as a decoder. In FIG. 2, data portion of input signal is processed by Huffman decoding unit 201 and scale factors are processed by Huffman decoding unit 203. The decoding by units 201 and 203 may be executed in parallel as shown in FIG. 2, or may be executed in a sequential manner. The outputs of the Huffman decoding units 201 and 203 are combined and provided to dequantizer 205, which in turn is coupled to stereo processing unit 207. The output of the stereo processing unit 207 is provided to special effect processing unit 209, which is coupled to inverse MDCT (Modified Discrete Cosine Transform) unit 211, which is coupled to synthesizer filter 213. The output of the synthesizer filter 213 is PCM signal modified by the special effect processing unit 209. The special effect processing unit 209 may perform a variety of signal processing task including equalization and base boost.

Unlike most prior art audio decoder systems, such as MP3 and AAC, that require a time-to-frequency domain conversion for audio special effect processing, the system shown in FIG. 2 eliminates the need for such intermediate time-to-frequency domain conversion by performing audio special effect processing within the decoding process in the frequency domain. Also, the system shown in FIG. 2 achieves the same function with fewer system elements than prior art audio decoders. Specifically, the system shown in FIG. 2 performs audio special effect processing such as equalization and base boost on input signal without requiring FFT 113 and inverse FFT 117 operations. The elimination of the FFT 113 and inverse FFT 117 operations allows to significantly reduce processing time and costs compared to the prior art systems while achieving adequate audio special effect.

In operation, the Huffman decoding units 201 and 203 performs decoding operation on input signal. The input signal is already compressed by a compression algorithm such as Huffman coding for efficient communications. Compressed input signals are decoded to recover original, uncompressed signal by the Huffman decoding units 201 and 203. Separate Huffman decoding units may be used to implement the units 201 and 203, or a single unit may be used to implement the routines performed by the units 201 and 203. For example, a same decoder may be used to sequentially process the data portion and scale factor portion of the input signal. The inverse quantization unit 205 performs inverse quantization to recover an approximated form of the original waveform to the extent allowed by quantization levels.

Inverse dequantization is typically a lossy process due to quantization noises introduced in a quantization process. The stereo processing unit 207 may perform a variety of two track processing operations including L-R coding (Left-to-Right channel), M-S (Middle-Side) coding, and/or intensity coding.

The special effect processing unit 209 receives the output of the stereo processing unit 207 and performs one or more special effect processing such as equalization and base boost. The inverse MDCT unit 211 receives the output of the special effect processing unit 209 and performs inverse discrete cosine transform. For example, the unit 211 may perform MDCT (modified discrete cosine transform). The step 211 is an optional step for rearranging a vector matrix, and depends on the signal processing step performed for encoding the input signal. For example, if the encoding process included an MDCT step, the unit 211 would perform an inverse MDCT. If, on the other hand, the encoding process included some other type of processing such as discrete sine transform (DST) or discrete Fourier transform (DFT), the unit 211 may perform an inverse DST or an inverse DFT instead of inverse MDCT.

The synthesizer filter 213 receives the output of the inverse MDCT unit 211 and synthesizes a time-domain signal that may be used to generate audible sounds. The synthesizer filter 213 may use an oscillator to synthesize time-domain signals and use various filters to enhance sound quality. Alone or in combination with the unit 211, the unit 213 performs a frequency-to-time domain conversion for a frequency-domain signal. The frequency-to-time signal conversion may be performed by an FFT (for AAC), polyphase filterbank—DCT combination (for MP3) or other suitable method.

It will be appreciated by one skilled in the art that various units shown in FIG. 2 may be implemented in hardware or software including firmware. For example, the inverse quantization unit 205, stereo processing unit 207, and special effect processing unit 209 may be implemented in hardware or in software such as firmware.

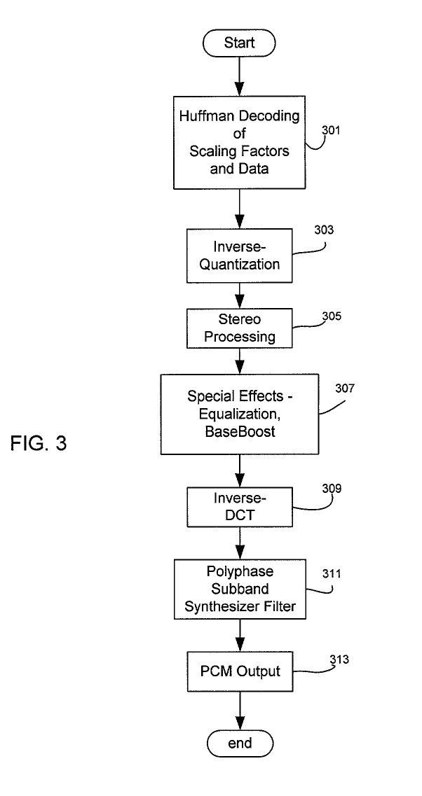

FIG. 3 illustrates a flowchart of signal processing in accordance with one embodiment of the invention. In step 301, data portion and scale factors of input signal are processed by Huffman decoding. As discussed earlier, the processing of the data portion and the scale factors in step 301 may be performed in parallel or sequentially. The outputs of the Huffman decoding are then inverse quantized in step 303. The output of the inverse quantization is stereo-processed in step 305. The output of the stereo processing is special-effect processed in step 307. The special effect processing may perform a variety of signal processing task including equalization and base boost. The output of the step 309 is processed by an inverse MDCT (Modified Discrete Cosine Transform) operation. In step 311, audible sound is generated by a synthesizer filter based on the output of the step 309, producing PCM signals 313, which have been equalized or base boosted by the special effect processing step 307. Examples of the synthesizer filter that may be used in step 311 include FFT or polyphase—DCT combination filter However, it will be appreciated by one skilled in the art that other suitable methods may be used in step 311.

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus the foregoing descriptions of specific embodiments of the present invention are presented for purposes of illustration description. They are not intended to be exhaustive or to limit the invention to the precise forms disclosed. It will be appreciated by those skilled in the art that changes in this embodiment may be made without departing from the principles and spirit of the invention, the scope of which is defined by the appended claims.

1. A computer program product for audio special effect in conjunction with a signal processing system, the computer program product comprising a computer readable storage medium and a computer program mechanism embedded therein, the computer program mechanism comprising:
(a) a decoding routine;
(b) an inverse quantization routine for receiving an output of the decoding routine and performing inverse quantization;
(c) a stereo processing routine for receiving an output of the inverse quantization routine and performing stereo processing;
(d) an audio special effect processing routine for receiving an output of the stereo processing routine and performing audio special effect processing; and
(e) an inverse discrete cosine transform (DCT) routine for receiving an output of the audio special effect processing routine and performing audio special effect processing;
wherein each said routine comprises software instructions.

2. The computer program product of claim 1 further comprising a synthesizer- filtering routine for receiving an output of the inverse discrete cosine transform routine and generating a time-domain signal.

3. The computer program product of claim 2 wherein said decoding routine comprises Huffman decoding.

4. The computer program product of claim 3 wherein said inverse discrete cosine transform (DCT) routine comprises an MDCT (modified discrete cosine transform).

5. The computer program product of claim 4 wherein said audio special effect processing comprises an equalization.

6. The computer program product of claim 4 wherein said audio special effect processing comprises a base boost.

7. A signal processing system for audio special effect comprising
a decoding unit;
an inverse quantization unit for receiving an output of the decoding unit and performing inverse quantization;
a stereo processing unit for receiving an output of the inverse quantization unit and performing stereo processing;
an audio special effect processing unit for receiving an output of the stereo processing unit and performing audio special effect processing; and
an inverse discrete cosine transform (DCT) unit for receiving an output of the audio special effect processing unit and performing audio special effect processing.

8. The signal processing system of claim 7 further comprising a synthesizer-filtering unit for receiving an output of the inverse discrete cosine transform unit and generating a time-domain signal.

9. The signal processing system of claim 8 wherein said decoding unit comprises Huffman decoding.

10. The signal processing system of claim 9 wherein said inverse discrete cosine transform (DCT) unit comprises an MDCT (modified discrete cosine transform).

11. The signal processing system of claim 10 wherein said audio special effect processing comprises an equalization.

12. The signal processing system of claim 10 wherein said audio special effect processing comprises a base boost.

13. A signal processing method for audio special effect processing, said method comprising
decoding an input signal;
performing inverse quantization unit on decoded input signal and generating a dequantized signal;
stereo processing said dequantized signal and generating a stereo processed signal;
performing an audio special effect processing on said stereo processed signal and generating a special effect signal; and
performing an inverse discrete cosine transform (DCT) on said special effect signal and generating a transformed signal.

14. The signal processing method of claim 13 further comprising:
a synthesizer filtering unit for generating a time domain signal based on said transformed signal.

15. The signal processing method of claim 14 wherein said decoding comprises Huffman decoding.

16. The signal processing method of claim 15 wherein said inverse discrete cosine transform (DCT) comprises an MDCT (modified discrete cosine transform).

17. The signal processing method of claim 16 wherein said audio special effect processing comprises an equalization.

18. The signal processing method of claim 16 wherein said audio special effect processing comprises a base boost.

19. A computer program product for audio special effect in conjunction with a signal processing system, the computer program product comprising a computer readable storage medium and a computer program mechanism embedded therein, the computer program mechanism comprising:
(a) a decoding routine for generating a decoded signal;
(b) an audio special effect processing routine for receiving said decoded signal and performing equalization and base boost; and
(c) a frequency-to-time converting routine;
wherein each said routine comprises software instructions.

20. The computer program product of claim 19 wherein said frequency-to-time converting routine comprises an inverse DCT routine for transforming an output of said audio special effect processing routine and a synthesizer-filtering routine for receiving an output of the inverse DCT routine and generating a time-domain signal.

21. The computer program product of claim 20 wherein said decoding routine comprises Huffman decoding.

22. The computer program product of claim 21 wherein said inverse discrete cosine transform (DCT) routine comprises an MDCT (modified discrete cosine transform).

23. The computer program product of claim 22 further comprising an inverse quantization routine for receiving said decoded signal and performing inverse quantization;

24. The computer program product of claim 23 further comprising a stereo processing routine for receiving an output of the inverse quantization routine and performing stereo processing.

25. A signal processing system for audio special effect comprising:
(a) a decoder unit for generating a decoded signal;
(b) an audio special effect processing unit for receiving said decoded signal and performing equalization and base boost for generating a specially processed signal; and
(c) a frequency-to-time converting routine for converting said specially processed signal to a time-domain signal.

26. The signal processing system of claim 25 wherein said frequency-to-time converting unit comprises an inverse DCT unit for transforming specially processed signal and a synthesizer-filtering routine for receiving an output of the inverse DCT routine and generating a time-domain signal.

27. The signal processing system of claim 26 wherein said decoding unit comprises Huffman decoding.

28. The signal processing system of claim 27 wherein said inverse discrete cosine transform (DCT) unit comprises an MDCT (modified discrete cosine transform).

29. The signal processing system of claim 28 further comprising an inverse quantization unit for receiving said decoded signal and performing inverse quantization;

30. The signal processing system of claim 29 further comprising a stereo processing routine for receiving an output of the inverse quantization unit and performing stereo processing.

31. A signal processing method for performing an audio special effect on an input signal, the method comprising:
decoding said input signal;
performing an audio special effect processing on said decoded signal and performing equalization and base boost for generating a specially processed signal; and
performing a frequency-to-time conversion for converting said specially processed signal to a time-domain signal.

32. The signal processing method of claim 31 wherein said frequency-to-time converting comprises:
performing an inverse DCT operation for transforming specially processed signal and a synthesizer-filtering for receiving an output of the inverse DCT operation and generating a time-domain signal.

33. The signal processing method of claim 32 wherein said decoding comprises Huffman decoding.

34. The signal processing method of claim 33 wherein said inverse discrete cosine transform (DCT) comprises an MDCT (modified discrete cosine transform).

35. The signal processing method of claim 34 further comprising:
performing an inverse quantization on said decoded signal.

36. The signal processing method of claim 35 further comprising:
performing a stereo processing on an output of the inverse quantization.
